(19) United States
(12) Patent Application Publication
(10) Pub. No.: US 2010/0001186 A1
(43) Pub. Date: Jan. 7, 2010

(54) METHOD OF MEASURING DIMENSION OF PATTERN AND RECORDING MEDIUM STORING PROGRAM FOR EXECUTING THE SAME

(76) Inventors: Soon-sik HWANG, Bucheon-si (KR); Byung-sam Choi, Suwon-si (KR); Ki-chul Park, Suwon-si (KR)

Correspondence Address: F. CHAU & ASSOCIATES, LLC, 130 WOODBURY ROAD, WOODBURY, NY, 11797, US

(21) Appl. No.: 12/483,997

(22) Filed: Jun. 12, 2009

(30) Foreign Application Priority Data
Jul. 1, 2008 (KR) 10-2008-0063632

(51) Int. Cl. G01N 23/04

(52) U.S. Cl. 250/311

(57) ABSTRACT

A method of measuring a dimension of a measurement pattern by using a scanning electron microscope is provided. The method of measuring the dimension of the pattern includes: (a) moving to a correction pattern that is adjacent to the measurement pattern. The correction pattern comprises circular patterns to correct focus and/or stigmatism of the scanning electron microscope with respect to the correction pattern. The method further includes (b) measuring the dimension of the measurement pattern under measurement conditions to which the corrected focus and/or the stigmatism are reflected.

### CROSS-REFERENCE TO RELATED APPLICATIONS

This application claims the benefit of Korean Patent Application No. 10-2008-0063632, filed on Jul. 1, 2008, the disclosure of which is hereby incorporated by reference herein in its entirety.

### BACKGROUND

(i) Technical Field

The present invention relates to a method of measuring a dimension of a pattern and to a recording medium storing a program for executing the same, and more particularly, to a method of measuring a dimension of a pattern of a semiconductor device by using a scanning electron microscope (SEM) and a recording medium storing a program for executing the same.

(ii) Description of the Related Art

In manufacturing semiconductor devices, accurate measurements of a dimension of a pattern may be required, and in a current semiconductor manufacturing process, the dimension of a pattern of a semiconductor device is generally measured by using an in-line SEM.

A SEM is a microscope that uses an electron beam (e-beam) to produce a magnified image of the sample.

When the dimension of a measurement pattern is measured using a SEM, it may be necessary to set optimal focus and/or stigmatism of the SEM with respect to the measurement pattern. However, when a top surface of the measurement pattern is coated with a photosensitive film, correcting the focus and/or stigmatism by directly irradiating an electron beam to the measurement pattern can damage the photosensitive film because the electron beam has energy. Consequently, as a result, when the photosensitive film is exposed to the electron beam for over a certain time, physical and/or chemical properties of materials constituting the photosensitive film may vary.

Therefore, there is a need in the art to develop a method of measuring a dimension of a measurement pattern by setting optimal focus and/or stigmatism conditions to a SEM, without damaging the measurement pattern.

### SUMMARY

Exemplary embodiments of the present invention may provide a method of measuring a dimension of a pattern by setting optimal focus and/or stigmatism conditions using a scanning electron microscope (SEM), without damaging the pattern to be measured.

Exemplary embodiments of the present invention may also provide a recording medium storing a program for executing the method of measuring the dimension of the pattern.

Exemplary embodiments of the present invention may also provide a semiconductor device pattern suitable for use in the method of measuring the dimension of the pattern.

In accordance with an exemplary embodiment of the present invention, a method of measuring a dimension of a measurement pattern by using a scanning electron microscope is provided. The method includes: (a) moving to a correction pattern that is adjacent to the measurement pattern. The correction pattern includes circular patterns to correct focus and/or stigmatism of the scanning electron microscope with respect to the correction pattern. The method further includes (b) measuring the dimension of the measurement pattern under measurement conditions to which the corrected focus and/or the stigmatism are reflected.

The correction pattern may be a pattern in which a plurality of the circular patterns constitutes an array. For example, the correction pattern may be disposed such that the plurality of the circular patterns constitutes an array with an n×m arrangement at a magnification to be measured, wherein n and m are each independently an integer. For example, correction pattern may be disposed such that the plurality of the circular patterns constitutes an array with a 2×2 arrangement or an array with a 3×3 arrangement at a magnification to be measured.

The correction pattern may be disposed within about 5 μm from the measurement pattern.

The measurement pattern may be formed after a photolithography process and before an etching process. The measurement pattern may be formed after a photolithography process and an etching process. The measurement pattern may be coated with a photosensitive film pattern. Here, the photolithography process may use an ArF light source.

In accordance with another exemplary embodiment of the present invention, a computer readable medium embodying instructions executable by a processor to perform a method of measuring a dimension of a measurement pattern using a scanning electron microscope is provided. The method includes (a) moving to an addressing point as a reference to search for a measurement pattern, (b) moving to a correction pattern including circular patterns and (c) correcting focus and/or stigmatism with respect to the correction pattern. The method further includes (d) moving to the measurement pattern and (e) measuring the dimension of the measurement pattern under measurement conditions to which the corrected focus and/or the stigmatism are reflected.

### BRIEF DESCRIPTION OF THE DRAWINGS

Exemplary embodiments of the present invention can be understood in more detail from the following detailed description taken in conjunction with the accompanying drawings in which:

FIG. 1 is a plan view of a semiconductor device pattern for explaining a method of measuring a dimension of a measurement pattern by using a scanning electron microscope (SEM) according to an exemplary embodiment of the present invention;

FIG. 2 is a schematic diagram illustrating a configuration of an apparatus for correcting stigmatism with respect to a tetragonal dummy pattern, according to an exemplary embodiment of the present invention;

FIG. 3 is a plan view of a semiconductor device pattern for explaining a method of measuring a dimension of a measurement pattern by using a SEM according to an exemplary embodiment of the present invention;

FIG. 4 is a cross-sectional view illustrating a correction pattern used in a method of measuring a dimension of a measurement pattern by using a SEM according to an exemplary embodiment of the present invention;

FIG. 5 is a schematic diagram illustrating a configuration of an apparatus for correcting stigmatism with respect to a circular correction pattern, according to an exemplary embodiment of the present invention;

FIG. 6A is an enlarged SEM image of a measurement pattern M after focus and/or stigmatism is corrected with respect to a tetragonal dummy pattern, according to an exemplary embodiment of the present invention;

FIG. 6B is an enlarged SEM image of a measurement pattern M after focus and/or stigmatism is corrected with respect to a circular correction pattern, according to an exemplary embodiment of the present invention; and

FIG. 7 is a flowchart for explaining a method of measuring a dimension of a measurement pattern by using a SEM according to an exemplary embodiment of the present invention.

### DETAILED DESCRIPTION OF THE EXEMPLARY EMBODIMENTS OF THE PRESENT INVENTION

The present invention will now be described more fully with reference to the accompanying drawings, in which exemplary embodiments of the present invention are shown.

Exemplary embodiments of the present invention may, however, be provided for a more complete description of the present invention to one of ordinary skill in the art, and the present invention may be embodied in many different forms and should not be construed as being limited to the exemplary embodiments set forth herein. In the drawings, the thickness and size of each layer are exaggerated for convenience and clarity of illustration.

It will be understood that when an element, such as a layer, a region, or a substrate, is referred to as being “on”, “connected to” or “coupled to” another element, it may be directly “on”, “connected to” or “coupled to” the other element or intervening elements may be present. In contrast, when an element is referred to as being “directly on,” “directly connected to” or “directly coupled to” another element, there are no intervening elements present. Like reference numerals refer to like elements throughout. As used herein, the term “and/or” includes any and all combinations of one or more of the associated listed items.

It will be understood that, although the terms first, second etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “above,” “upper,” “below,” and “lower,” may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “above” other elements would then be oriented “below” the other elements. Thus, the exemplary term “above” may encompass both an orientation of above and below. The device may be otherwise oriented (rotated 90 degrees or at other orientations) and the spatially relative descriptors used herein may be interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

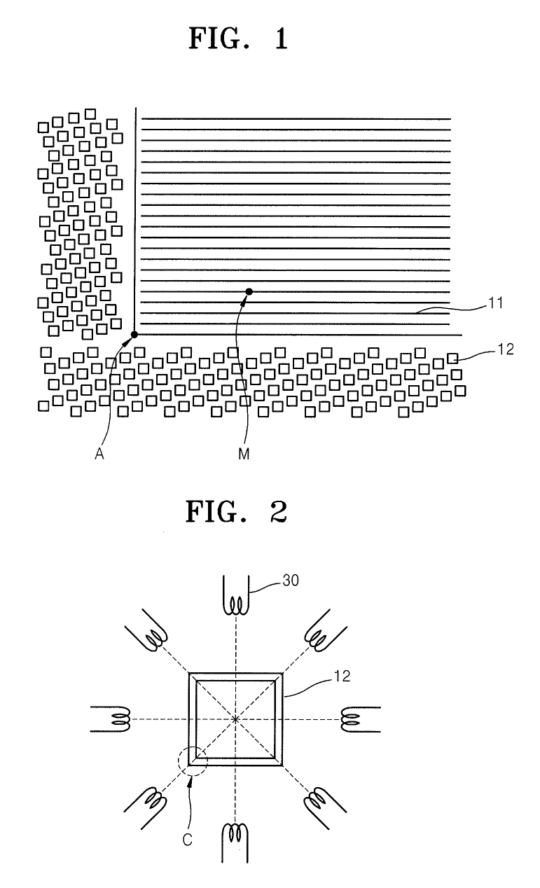

FIG. 1 is a plan view of a semiconductor device pattern for explaining a method of measuring a dimension of a measurement pattern by using a scanning electron microscope (SEM).

Referring to FIG. 1, a semiconductor device pattern including a main pattern 11 and a plurality of dummy patterns 12 is disposed. The main pattern 11 includes a measurement pattern M of which the dimension is to be measured using a SEM. The dimension may be, for example, a critical dimension of the measurement pattern M. An addressing point A may act as a reference to facilitate searching for the pattern M.

When a top surface of the measurement pattern M is coated with a photosensitive film, correcting focus and/or stigmatism by directly irradiating an electron beam to the measurement pattern M may result in damage to the photosensitive film.

Thus, the correction of the focus and/or stigmatism with respect to the measurement pattern M is not directly carried out on the measurement pattern M, and may instead be carried out on another pattern. For example, it is preferable that the focus and/or stigmatism of the SEM is optimized for the dummy pattern 12 adjacent to the main pattern 11, and then the dimension of the measurement pattern M is measured under measurement conditions to which the above condition is reflected.

In FIG. 1, the plurality of dummy patterns 12, each having a tetragonal shape, are disposed regularly apart from each other. However, it was confirmed that when the focus and/or stigmatism is corrected with respect to the dummy patterns 12 each having a tetragonal shape, the accuracy of the measurement of the dimension of the measurement pattern M may be decreased as the size of pattern M becomes small. This is because a type of signal may be distorted on a corner of the tetragonal shape.

FIG. 2 is a schematic diagram illustrating a configuration of an apparatus for correcting stigmatism with respect to a tetragonal dummy pattern 12.

Referring to FIG. 2, the apparatus for correcting stigmatism may include, for example, 4 pairs of stigmators 30. When the dummy pattern 12 has a tetragonal shape, the signal corresponding to the corner C of the tetragonal shape of the dummy pattern 12 is different from the signal corresponding to other sides of the tetragonal shape of the dummy pattern 12 and thus, the ability of correcting stigmatism may be decreased.

Therefore, exemplary embodiments of the present invention provide that a shape of a correction pattern for correcting the focus and/or stigmatism be symmetrical with respect to the stigmators 30 from all directions. The correction pattern having a shape symmetrical with respect to the stigmators 30 from all directions may be, for example, a circular correction pattern. The term “circular correction pattern” refers to a pattern of which the shape in a cross-sectional direction parallel to a semiconductor substrate is circular.

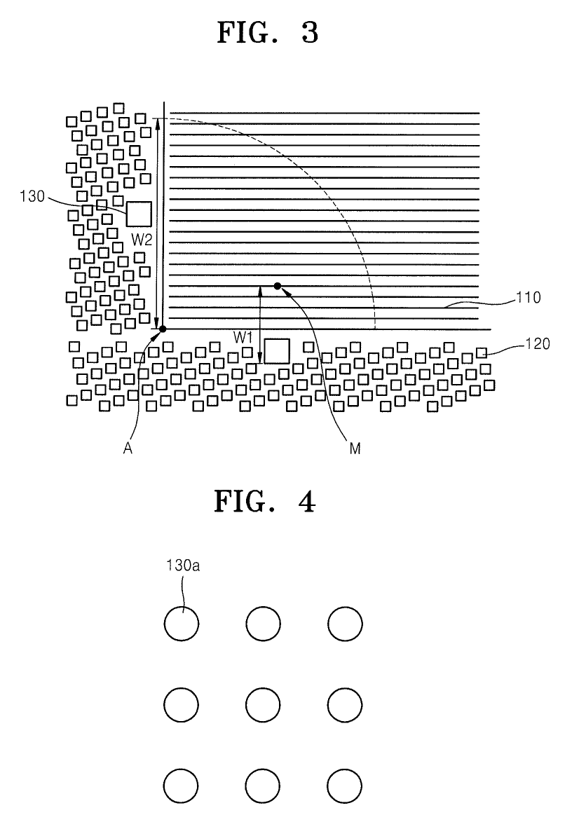

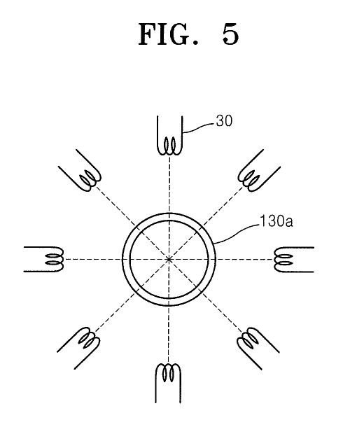

FIG. 3 is a plan view of a semiconductor device pattern for explaining a method of measuring a dimension of a measurement pattern M by using a SEM according to an exemplary embodiment of the present invention. FIG. 4 is a cross-sectional view illustrating a correction pattern used in a method of measuring a dimension of a measurement pattern M by using a SEM according to an exemplary embodiment of the present invention. FIG. 5 is a schematic diagram illustrating a configuration of an apparatus for correcting stigmatism with respect to a circular correction pattern, according to an exemplary embodiment of the present invention.

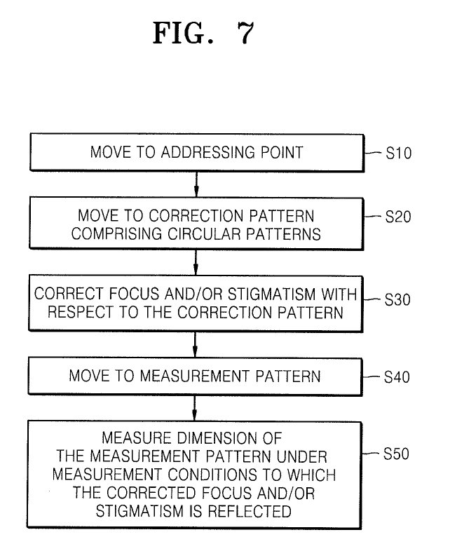

Also, FIG. 7 is a flowchart for explaining a method of measuring a dimension of a measurement pattern M by using a SEM according to an exemplary embodiment of the present invention.

Referring together to FIGS. 3, 4 and 7, first, the method of measuring the dimension of the measurement pattern M by using the SEM includes moving to an addressing point A acting as a reference to readily search for the measurement pattern M (operation S10). The measurement pattern M may be positioned within a predetermined distance W2 from the addressing point A, and for example, the predetermined distance W2 may be within about 10 μm. Then, the method of exemplary embodiments of the present invention includes moving to a correction pattern 130a comprising circular patterns (operation S20), and correcting focus and/or stigmatism with respect to the correction pattern 130a (operation S30). The correction pattern 130a may be a pattern in which a plurality of circular patterns constitutes an array. For example, the correction pattern 130a may be a pattern in which the plurality of circular patterns can be viewed as an array with an n×m arrangement on a screen of the SEM at a magnification to be measured. In this regard, n and m are each independently an arbitrary positive integer value, and preferably, n and/or m may have a positive integer value that is 2 or greater.

For example, when the dimension of the measurement pattern M is measured using the SEM at a magnification of about 100,000 times, the array of the correction pattern 130a may be disposed such that the array with the n×m arrangement, where n and m are each independently a positive integer value, can be viewed on the screen of the SEM at a magnification of about 100,000 times. For example, the array of the correction pattern 130a may be disposed such that an array pattern with a 3×3 arrangement can be fully viewed on the screen of the SEM at a measurement magnification of about 100,000 times.

Although an outer portion 130 of the correction pattern 130a in which the plurality of circular patterns constitute an array is illustrated to have a tetragonal shape in FIG. 3, the correction pattern 130a obviously comprises circular patterns.

In addition, the correction pattern 130a may be formed adjacent to the dummy pattern 120 that may have a tetragonal shape. In general, in forming the semiconductor device pattern, it is easier to form a tetragonal shape than to form a circular shape, and thus the shape of the dummy pattern 120 is not limited in exemplary embodiments of the present invention.

Referring to FIG. 5, the apparatus for correcting stigmatism may include, for example, 4 pairs of stigmators 30. A correction pattern 130a has a circular shape, and thus is symmetrical with respect to the stigmators 30 from all directions. Accordingly, the type of signal is also symmetrical from all directions. Therefore, when the correction pattern 130a having a circular shape is applied rather than a correction pattern having a tetragonal shape, the ability of correcting stigmatism may be improved.

Then, the method of measuring the dimension of the measurement pattern by using the SEM includes moving to the measurement pattern M (operation S40). The measurement pattern M may be a pattern formed after a photolithography process and before an etching process, or may be a pattern formed after the photolithography process and the etching process. In this case, the measurement pattern M may be a pattern of which top surface is coated with a photosensitive film pattern.

The photolithography process may use, for example, a KrF light source, an ArF light source, or X-rays. For example, in a method of manufacturing a semiconductor device pattern having a critical dimension in the range of about 22 to about 32 nm, the photolithography process using the ArF light source may be applied. However, it is apparent to one of ordinary skill in the art that exemplary embodiments of the present invention are not limited to these photolithography processes.

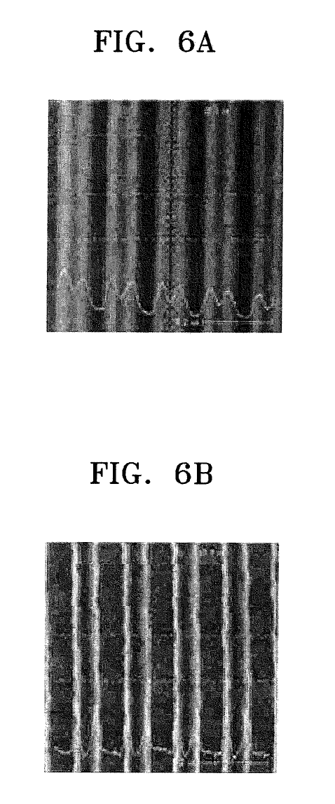

FIG. 6A is an enlarged SEM image of a measurement pattern M after focus and/or stigmatism is corrected with respect to a tetragonal dummy pattern. FIG. 6B is an enlarged SEM image of a measurement pattern M after focus and/or stigmatism is corrected with respect to a circular correction pattern, according to an exemplary embodiment of the present invention.

Referring to FIGS. 6A and 6B, the measurement pattern M may be, for example, configured as a line and space pattern.

When the focus and/or stigmatism are corrected with respect to the tetragonal dummy pattern, and then the measurement pattern M is enlarged using the SEM, as illustrated in FIG. 6A, an interface between a line pattern and a space pattern may be indefinite and the focus may be poor.

In contrast, when the focus and/or stigmatism are corrected with respect to the circular correction pattern, and then the measurement pattern M is enlarged using the SEM, as illustrated in FIG. 6B, the interface between the line pattern and the space pattern may be definite and the focus may be good.

Therefore, according to the method of measuring the dimension of the measurement pattern of exemplary embodiments of the present invention, the dimension of the measurement pattern M can be relatively accurately measured, and thus accurate feedback in a process of manufacturing a semiconductor device is possible. Accordingly, unnecessary rework processes can be eliminated, resulting in contribution to lower manufacturing costs of a semiconductor device.

Then, exemplary embodiments of the present invention may also provide a recording medium storing a program for executing the method of measuring the dimension of the measurement pattern.

Computer systems involving programming, including executable software code, may be used to implement the above described method of measuring the dimension of the measurement pattern. As the method has been described, a detailed description thereof will be omitted here. The software code is executable by a general-purpose computer. In operation, the software code and the associated data records are stored within a general-purpose computer platform. At other times, however, the software code may be stored at other locations and/or transported for lading into appropriate general-purpose computer systems. Hence, embodiments involve one or more software products with respect to code carried by at least one machine-readable medium. Execution of such code by a processor of the computer system enables the platform to implement the catalog and/or software downloading functions, in essentially the manner performed in the embodiments discussed and illustrated herein. As used herein, terms such as computer or “readable medium” refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s) operating as one of the server platform. Volatile media include, for example, dynamic memory, such as main memory of such a computer platform. Physical transmission media include, for example, coaxial cables, copper wire and fiber optics, including the wires that comprise a bus within a computer system. Carrier-wave transmission media can take the form of, for example, electric or electromagnetic signals, or acoustic or light waves such as those generated during radio frequency (RF) and infrared (IR) data communications. Common forms of computer-readable media therefore include, for example; a floppy disk, a flexible disk, hard disk, magnetic tape, any other magnetic medium, a CD-ROM, DVD, any other optical medium, less commonly used media such as punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Exemplary embodiments of the present invention may also provide a semiconductor device pattern comprising a measurement pattern; and a correction pattern, wherein the correction pattern is a pattern for correcting focus and/or stigmatism of a SEM to measure a dimension of the measurement pattern by using the SEM, and the correction pattern comprises circular patterns. The correction pattern may be a pattern in which a plurality of circular patterns constitutes an array. For example, the correction pattern may be disposed such that the plurality of circular patterns constitutes an array with n×m arrangement at a magnification to be measured, where n and m are each independently a positive integer.

However, exemplary embodiments of the present invention are not limited to a correction pattern that comprises circular patterns. Rather, the correction pattern may be any correction pattern having a shape symmetrical with respect to the stigmators 30 (Refer to FIG. 5) from all directions and that corrects stigmatism in the SEM.

The correction pattern may be disposed, for example, within about 5 μm from the measurement pattern.

Having described the exemplary embodiments of the present invention, it is further noted that it is readily apparent to those of reasonable skill in the art that various modifications may be made without departing from the spirit and scope of the invention which is defined by the metes and bounds of the appended claims

What is claimed is:

1. A method of measuring a dimension of a measurement pattern by using a scanning electron microscope, the method comprising:
(a) moving to a correction pattern that is adjacent to the measurement pattern, the correction pattern comprises circular patterns to correct focus and/or stigmatism of the scanning electron microscope with respect to the correction pattern; and
(b) measuring the dimension of the measurement pattern under measurement conditions to which the corrected focus and/or the stigmatism are reflected.

2. The method of claim 1, wherein the correction pattern is a pattern in which a plurality of the circular patterns constitutes an array.

3. The method of claim 2, wherein the correction pattern is disposed such that the plurality of the circular patterns constitutes an array with an n×m arrangement at a magnification to be measured, wherein n and m are each independently an integer.

4. The method of claim 2, wherein the correction pattern is disposed such that the plurality of the circular patterns constitutes an array with a 2×2 arrangement or an array with a 3×3 arrangement at a magnification to be measured.

5. The method of claim 1, wherein the correction pattern is disposed within about 5 μm from the measurement pattern.

6. The method of claim 1, wherein the measurement pattern is formed after a photolithography process and before an etching process.

7. The method of claim 1, wherein the measurement pattern is formed after a photolithography process and an etching process.

8. The method of claim 1, wherein the measurement pattern is coated with a photosensitive film pattern.

9. The method of claim 6, wherein the photolithography process uses an ArF light source.

10. The method of claim 7, wherein the photolithography process uses an ArF light source.

11. A computer readable medium embodying instructions executable by a processor to perform a method of measuring a dimension of a measurement pattern using a scanning electron microscope, the method comprising:
(a) moving to an addressing point as a reference to search for a measurement pattern;
(b) moving to a correction pattern comprising circular patterns;
(c) correcting focus and/or stigmatism with respect to the correction pattern;
(d) moving to the measurement pattern; and
(e) measuring the dimension of the measurement pattern under measurement conditions to which the corrected focus and/or the stigmatism are reflected.

12. The method of claim 11, wherein the measurement pattern is positioned within a predetermined distance from the addressing point, and wherein the predetermined distance is within 10 μm.

13. The method of claim 11, wherein an apparatus which includes four pairs of stigmators is used for correcting the stigmatism and wherein the correction pattern comprising the circular patterns is symmetrical with respect to the stigmators from all directions.

14. The method of claim 11, wherein the correction pattern is a pattern in which a plurality of the circular patterns constitutes an array.

15. The method of claim 14, wherein the correction pattern is disposed such that the plurality of the circular patterns constitutes an array with an n×m arrangement at a magnification to be measured, wherein n and m are each independently a positive integer value of 2 or greater.

16. The method of The method of claim 1 1, wherein the measurement pattern is formed after a photolithography process and before an etching process.

17. The method of claim 11, wherein the measurement pattern is formed after a photolithography process and an etching process.

18. The method of claim 11, wherein a top surface of the measurement pattern is coated with a photosensitive film pattern.

19. The method of claim 11, wherein the instructions executed by the processor for performing the method of measuring the dimension of the measurement pattern is executable software code.

20. The method of claim 19, wherein the computer readable medium includes a floppy disk, a flexible disk, a hard disk, magnetic tape, a CD-ROM, and a DVD.
